(19) United States
(12) Patent Application Publication
(10) Pub. No.: US 2026/0208048 A1
(43) Pub. Date: Jul. 23, 2026

(54) INFORMATION PROCESSING APPARATUS AND AGENT GENERATION METHOD

(71) Applicant: Sony Interactive Entertainment Inc., Tokyo (JP)

(72) Inventors: TEIJI YUTAKA, Kanagawa (JP); Hiroyuki Segawa, Kanagawa (JP); Kazuyuki Arimatsu, Tokyo (JP); Ryota Murasugi, Chiba (JP)

(73) Assignee: Sony Interactive Entertainment Inc., Tokyo (JP)

(21) Appl. No.: 19/137,911

(22) PCT Filed: Dec. 23, 2022
(86) PCT No.: PCT/JP2022/047627

§ 371 Date: Jun. 11, 2025

(51) Int. Cl. A63F 13/60; A63F 13/79

(52) U.S. Cl. CPC A63F 13/60; A63F 13/79

(57) ABSTRACT

Provided is a technology of generating an agent to play a game on behalf of a user. A recording device 240 records user data 242 including user information 244 regarding multiple users and/or user play data 246 about game plays performed by multiple users. A user identification section 222 identifies a second user who is different from a first user. An agent generation section 220 generates an agent to play a game on behalf of the first user, using the user data 242 of the second user.

### TECHNICAL FIELD

The present disclosure relates to a technology of generating an agent to play a game on behalf of a user and/or a technology of controlling a game play being performed by an agent.

### BACKGROUND ART

PTL 1 discloses a system in which a game play is taken over to a game play controller, whereby an AI (artificial intelligence) character proceeds a game on behalf of a user. The game play controller trains the AI character to simulate a user's play style. Accordingly, when the AI character plays a game in a multiplayer gaming session, the presence of the user is maintained.

PTL 2 discloses a method of training a machine learning model so as to imitate a user's game play using game play data generated when a user plays a video game. The machine learning model is an artificial neural network, and learns and imitates the user's game play style and tendency. Since the machine learning model is trained, a user AI bot becomes able to implement a game play imitating the user.

### CITATION LIST

### Patent Literature

[PTL 1]JP 2019-520154T
[PTL 2] JP 2022-525413T

### SUMMARY

### Technical Problem

By causing an agent such as an AI character to play a game, a user can proceed the game. One object of the present disclosure is to provide a technology of generating an agent. Another object of the present disclosure is to provide a technology of controlling a game play being performed by an agent.

### Solution to Problem

In order to solve the above problems, an information processing apparatus according to a certain aspect of the present disclosure includes a recording device that records user data including user information regarding multiple users and/or play data regarding game plays performed by multiple users, and at least one processor having hardware. The at least one processor identifies a second user who is different from a first user, and generates an agent to play a game on behalf of the first user, using user data of the second user.

An information processing apparatus according to another aspect of the present disclosure includes a recording device that records user data including user information regarding a user and/or play data regarding a game play performed by a user, and at least one processor having hardware. The at least one processor specifies a degree of reflection of the user data in generation of an agent to play a game, and generates an agent by using the user data according to the specified degree.

An agent generation method according to still another aspect of the present disclosure is a method of generating an agent to play a game in an information processing apparatus. The method includes identifying a second user who is different from a first user, and generating an agent to play a game on behalf of the first user, using user data including user information regarding the second user and/or play data regarding a game play performed by the second user.

An agent generation method according to yet another aspect of the present disclosure is a method of generating an agent to play a game in an information processing apparatus. The method includes specifying a degree of reflection of user data in generation of an agent, the user data including user information regarding a user and/or play data regarding a game play performed by a user, and generating an agent by using the user data according to the specified degree.

It is to be noted that a method, an apparatus, a system, a recording medium, or a computer program that is obtained by translating any combination of the above constituent elements or expressions in the present disclosure is also effective as an aspect of the present disclosure.

### BRIEF DESCRIPTION OF DRAWINGS

FIG. 1 is a diagram depicting a game system according to an embodiment.

FIG. 2 is a diagram depicting functional blocks of a terminal apparatus.

FIG. 3 is a diagram depicting functional blocks of a game server.

FIG. 4 is a diagram depicting an example of a play image.

FIG. 5 is a flowchart of generating an agent.

FIG. 6 is a diagram depicting an example of an inquiry screen.

FIG. 7 is a diagram depicting another example of an inquiry screen.

FIG. 8 is a diagram depicting an example of a user data reflection degree specification screen.

FIG. 9 is a diagram depicting another example of a user data reflection degree specification screen.

FIG. 10 is a diagram depicting an example of a play image of a game being operated by an agent.

FIG. 11 is a diagram depicting an example of a play content specification screen.

### DESCRIPTION OF EMBODIMENTS

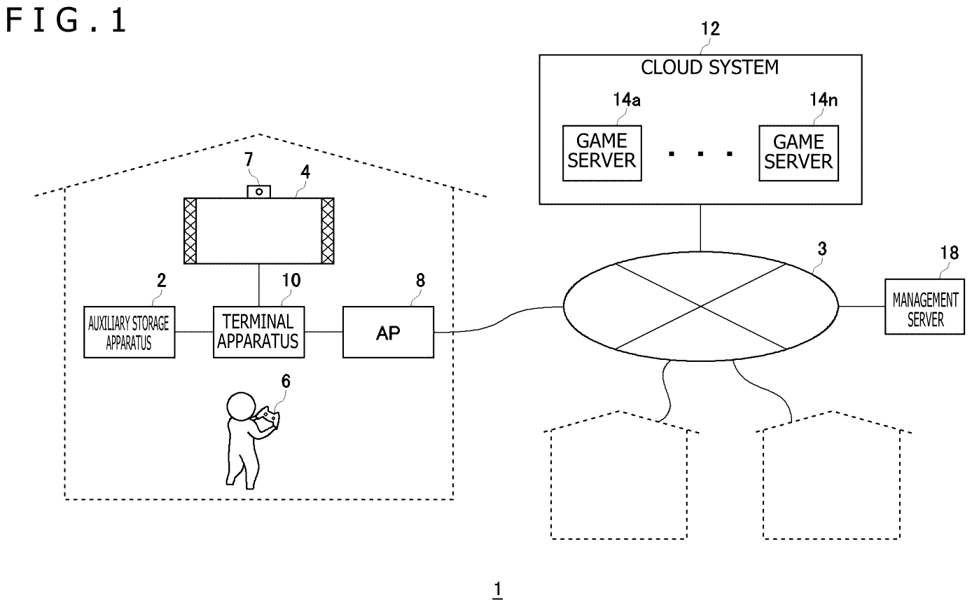

FIG. 1 is a diagram depicting a game system 1 according to an embodiment of the present disclosure. The game system 1 includes a terminal apparatus 10 to be operated by a user, a cloud system 12, and a management server 18, which are connected over a network 3 such as the internet or a LAN (Local Area Network). An access point (hereinafter, referred to as an “AP”) 8 has a wireless access point function and a router function. The terminal apparatus 10 is connected to the AP 8 wirelessly or via a wire, and is connected to the management server 18 and the cloud system 12 on the network 3 in a communicable manner.

The terminal apparatus 10 is connected wirelessly or wiredly to an input apparatus 6 which is operated by a user. The input apparatus 6 supplies user operation information to the terminal apparatus 10. The terminal apparatus 10 receives the operation information from the input apparatus 6, reflects the operation information in processing of system software or application software, and causes an output apparatus 4 to output the processing result. The input apparatus 6 may be an apparatus such as a game controller for supplying user operation information to the terminal apparatus 10. Alternatively, the input apparatus 6 may be an input interface such as a keyboard or a mouse.

The output apparatus 4 may be a television equipped with a display for outputting images and a speaker for outputting sounds. Alternatively, the output apparatus 4 may be a computer display. The output apparatus 4 may be connected to the terminal apparatus 10 via a wire cable or without a cable. An auxiliary storage apparatus 2 is storage such as an HDD (hard disk drive) or an SSD (solid state drive), and may be a built-in storage apparatus or may be an external storage apparatus that is connected to the terminal apparatus 10 via a USB (Universal Serial Bus) or the like. A camera 7 which is an image capturing apparatus is disposed near the output apparatus 4, and captures an image of a peripheral space of the output apparatus 4. In FIG. 1, the camera 7 is mounted on the upper portion of the output apparatus 4. The camera 7, however, may be disposed on a side portion or lower portion of the output apparatus 4. In either case, the camera 7 is disposed in a position to be able to capture an image of a user who is positioned forward of the output apparatus 4. The camera 7 may be a stereo camera. It is to be noted that the camera 7 can be omitted from the game system 1.

In the game system 1, the management server 18 offers a network service to a user operating the terminal apparatus 10. The management server 18 manages network accounts for identifying users. A user uses a network account to sign in to the network service. When a user signs in to the network service, the management server 18 offers information indicating the current status of a friend to the user, and manages the acquisition status of virtual prizes (trophies) given by the game to the user.

When signing in to the network service, a user can use a cloud gaming service offered by the cloud system 12. The cloud system 12 includes multiple game servers 14a, . . . , 14n (hereinafter, referred to as the “game server 14” unless otherwise specified) to constitute the cloud gaming system. The multiple game servers 14 execute different types of game programs, so that the user can enjoy multiple types of cloud games. Each game server 14 may be maintained and managed by a management entity of the corresponding cloud gaming service.

When the user operates the input apparatus 6 during a game play, the terminal apparatus 10 offers the game operation information to the game server 14 via the network 3. The game server 14 receives the user's game operation information, executes a game program using the operation information, and generates play images and play sounds of the game. It is to be noted that a play image and play sound generated by the game server 14 may be hereinafter referred to simply as a “play image” for convenience of explanation. A play image generated by the game server 14 is streamed to the terminal apparatus 10, and the terminal apparatus 10 outputs the streamed play image from the output apparatus 4.

In the game system 1 according to the embodiment, a user can cause an agent to play a game on behalf of the user. During a game play being performed by the agent, the user does not perform any game operation for the game while the agent autonomously or automatically plays the game. By way of example, if the user is unable to perform a game operation due to a meal or work, the agent plays the game on behalf of the user, whereby the game can be proceeded. It is to be noted that the user also can take over operation of a game being played by the agent.

The agent according to the embodiment can be generated by machine learning of play data regarding past game plays performed by the user and/or other users. The game server 14 is provided with a trained machine learning model to implement an agent that autonomously or automatically generates a command according to the progress status of the game. The agent may generate operation information regarding the input apparatus 6 corresponding to a game command, and supply the operation information to the game. It is to be noted that the trained machine learning model may be provided to the terminal apparatus 10, and a game command or game operation information may be supplied to the game server 14 via the network 3.

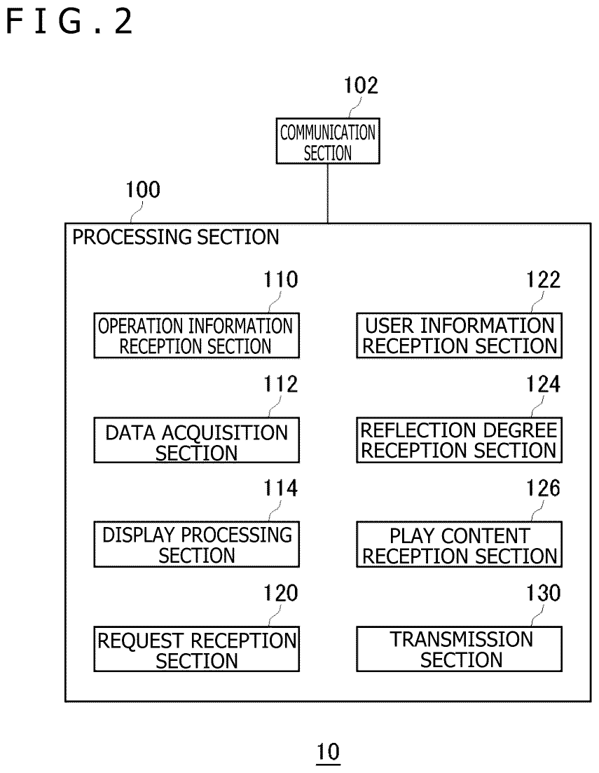

FIG. 2 depicts functional blocks of the terminal apparatus 10. The terminal apparatus 10 according to the embodiment includes a processing section 100 and a communication section 102, and has a function of displaying a game play image on the output apparatus 4. The processing section 100 includes an operation information reception section 110, a data acquisition section 112, a display processing section 114, a request reception section 120, a user information reception section 122, a reflection degree reception section 124, a play content reception section 126, and a transmission section 130.

The terminal apparatus 10 is an information processing apparatus including a computer. By the computer executing a program, the various functions depicted in FIG. 2 are implemented. The computer is provided with a memory to which the program is loaded, at least one processor which executes the loaded program, an auxiliary storage, any other LSI (Large-Scale Integration), etc., by hardware. The processor may be formed of multiple electronic circuits including a semiconductor integrated circuit and LSI, and the multiple electronic circuits may be mounted on a single chip or may be mounted on multiple chips. The functional blocks depicted in FIG. 2 are implemented by hardware and software in cooperation. Therefore, a person skilled in the art will understand that these functional blocks can be implemented in many different ways by hardware, by software, or a combination thereof.

The communication section 102 receives information (operation information) regarding a game operation performed on the input apparatus 6 by a user, and provides the information to the operation information reception section 110. Further, the communication section 102 exchanges various kinds of information or data by communicating with the management server 18 and the game server 14. The communication section 102 may have both a wireless communication module function and a wired communication module function.

A user accesses the game server 14 that offers a game to be played by the user, and starts a game play. During the game play, the user performs an operation on the input apparatus 6, the operation information reception section 110 receives the game operation information, and the transmission section 130 transmits the operation information to the game server 14 via the communication section 102.

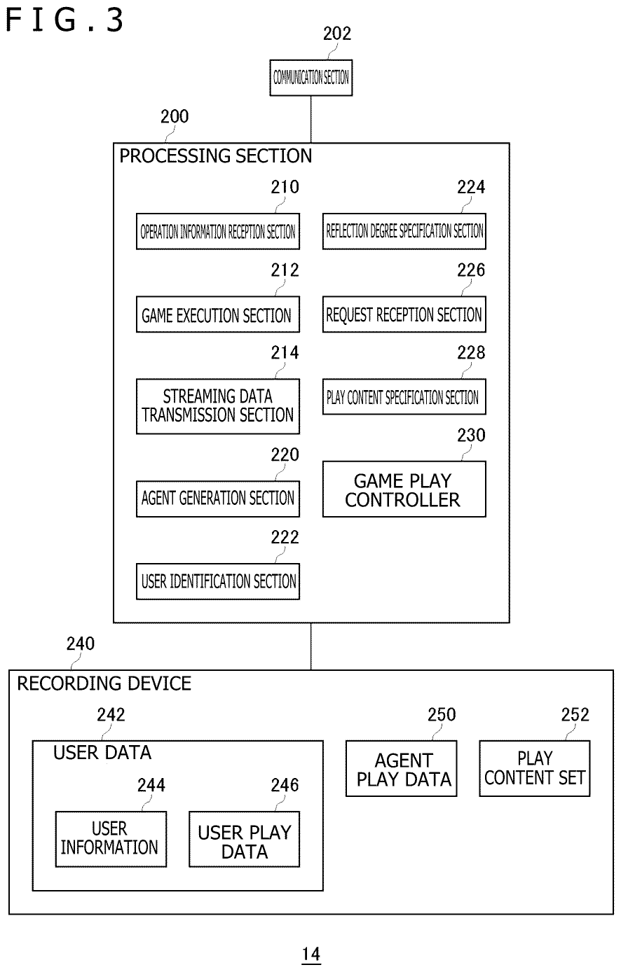

FIG. 3 depicts functional blocks of the game server 14. The game server 14 according to the embodiment includes a processing section 200, a communication section 202, and a recording device 240. The processing section 200 includes an operation information reception section 210, a game execution section 212, a streaming data transmission section 214, an agent generation section 220, a user identification section 222, a reflection degree specification section 224, a request reception section 226, a play content specification section 228, and a game play controller 230. The agent generation section 220 generates an agent of a user. The game play controller 230 initiates the generated agent, and causes the agent to play a game.

The game server 14 is an information processing apparatus including a computer. By the computer executing a program, the various functions depicted in FIG. 3 are implemented. The computer is provided with a memory to which the program is loaded, at least one processor which executes the loaded program, an auxiliary storage, any other LSI, etc., by hardware. The processor may be formed of multiple electronic circuits including a semiconductor integrated circuit and LSI, and the multiple electronic circuits may be mounted on a single chip or may be mounted on multiple chips. The functional blocks depicted in FIG. 3 are implemented by hardware and software in cooperation. Therefore, a person skilled in the art will understand that these functional blocks can be implemented in many different ways by hardware, by software, or a combination thereof.

During a user's game play, the operation information reception section 210 receives user operation information, and the game execution section 212 executes a computation process of animating a player character in a virtual space on the basis of the user operation information. The game execution section 212 includes a GPU (Graphics Processing Unit). In response to a result of the computation process in the virtual space, the game execution section 212 generates data on a game image from a view point (virtual camera) in the virtual space. In addition, the game execution section 212 generates data on a game sound from the viewpoint in the virtual space. The streaming data transmission section 214 transmits streaming data which includes the game image data and the game sound data to the terminal apparatus 10 of the user.

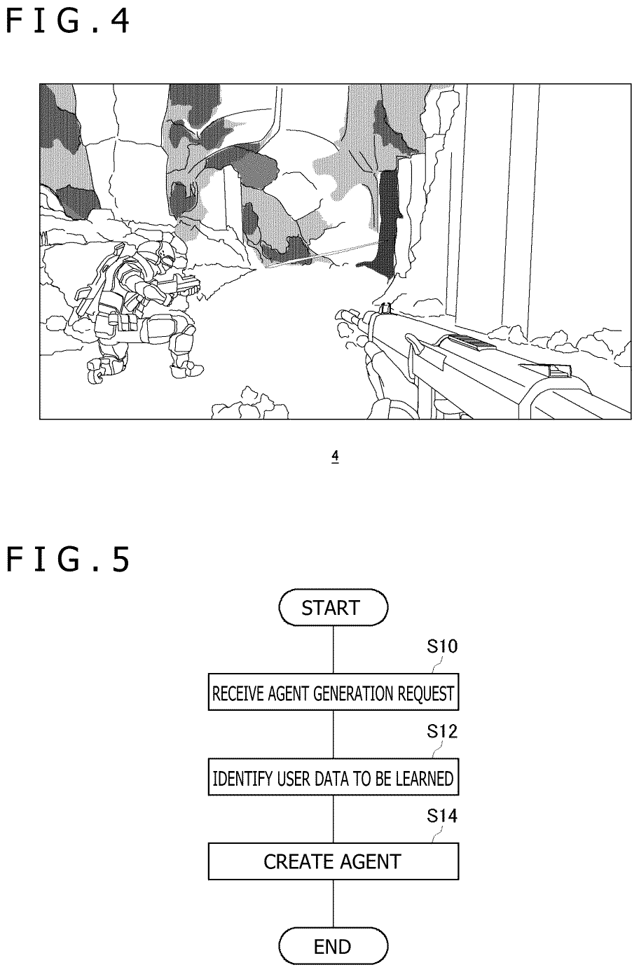

FIG. 4 depicts an example of a play image displayed on the output apparatus 4. In the terminal apparatus 10, the data acquisition section 112 acquires the streaming data from the game server 14, and the display processing section 114 displays a game play image on the output apparatus 4.

In the game server 14, the recording device 240 records information regarding multiple users (hereinafter, also referred to as “user information 244”). The user information 244 may include login times of the users to the terminal apparatuses 10, the genres of games played by the users, personal information including the ages and sexes of the users, information regarding trophies acquired by the users, information regarding friends of the users, etc. The user information is managed by the management server 18. The game server 14 may acquire user information of multiple users from the management server 18 and record the information in the recording device 240.

In addition, the recording device 240 records data regarding game plays performed by multiple users (hereinafter, also referred to as “user play data 246”). The user play data 246 may include operation history data in which operation information regarding the past user operations performed on the input apparatus 6 and their operation times are recorded in association with each other. In addition, the user play data 246 may include a past play image generated on the basis of the operation information and streamed by the user. In addition, the user play data 246 may include data acquired by the game server 14 which is, for example, data regarding a user's play time period, the progress status of a game, a user's favorite character or action, a user skill, etc.

In the game system 1, a user can request the game server 14 to generate an agent to play a game on behalf of the user. The game server 14 generates an agent of the user in the embodiment, but a server apparatus (information processing apparatus) that is separate from the game server 14 may generate an agent of the user.

In the embodiment, the user data 242 is used as learning data for training the machine learning model. The user data 242 may be teacher data for use in supervised learning. The user data 242 includes the user information 244 regarding multiple users and/or the user play data 246 about game plays performed by multiple users. Basically, the user data 242 includes both the user information 244 and the user play data 246, but may include only one of the user information 244 or the user play data 246.

The agent generation section 220 generates an agent by using the user data 242. In the embodiment, the agent generation section 220 trains a machine learning model (or an artificial intelligence model) using the user data. During a user's game play, the user recognizes the situation of the game while watching a play image, and proceeds the game by operating the input apparatus 6 according to the situation of the game. In one example, therefore, the machine learning model may be trained so as to, when receiving a game image (past play image) as teacher data, output a game command (or operation information regarding the input apparatus 6). In a case where a game image is an input to the machine learning model, the machine learning model may be a CNN (convolutional neural network) equivalent to a multilayer neural network including an input layer, one or more convolutional layers, and an output layer. The agent generation section 220 may cause the machine learning model to learn coupling coefficients (weights) in the CNN by a learning method such as deep learning.

It is to be noted that, in a case where the user play data 246 includes history data regarding user operations but does not include any past play image, the game execution section 212 may reproduce a play image by executing the game program based on the user operations history data, and the agent generation section 220 may train the machine learning model using the reproduced play image in the above-mentioned manner. It is to be noted that the agent generation section 220 may train the machine learning model by inputting the user operations history data on behalf of inputting a game image. In either case, the agent generation section 220 can train the machine learning model using the user play data 246, and can generate an agent.

An explanation will be given below of a process of generating an agent of a user A.

### First Embodiment

The user A operates the input apparatus 6 to input an agent generation request to the terminal apparatus 10, the request reception section 120 receives the agent generation request, and the transmission section 130 transmits the agent generation request to the game server 14. This embodiment is based on an assumption that the transmission section 130 transmits the agent generation request to one of the game servers 14 in the cloud system 12, but the agent generation request may be transmitted to the multiple game servers 14.

FIG. 5 is a flowchart in which the game server 14 generates an agent. In the game server 14, when the communication section 202 receives the agent generation request (S10), the agent generation section 220 starts an agent generation process, that is, learning (training) in the machine learning model. The agent generation section 220 sends an inquiry about whose user data is to be used for training the machine learning model, to the terminal apparatus 10 of the user A.

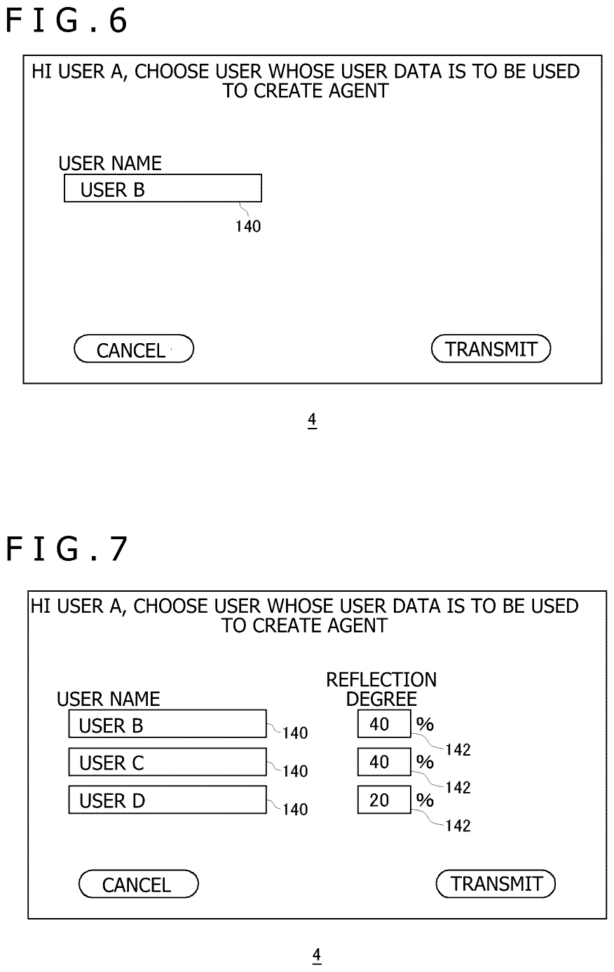

FIG. 6 depicts an example of an inquiry screen displayed on the output apparatus 4. In an entry area 140 on the inquiry screen, the user A enters information for identifying a user whose user data is to be learned. The information for identifying a user is information for uniquely identifying the user in the game system 1. The information may be a name, a nickname, or a network account of the user. In this example, the user A selects to use the user data of a user B for generating an agent. When the user A enters information for identifying the user B in the entry area 140, the user information reception section 122 receives the selection of the user B.

The user A may be allowed to select a user from among all users participating in the game system 1. Alternatively, the user A may be allowed to select only a user who has a specific relation with the user A. By way of example, the user A may be allowed to select only a user who has a friend relation with the user A. The user A enters user identification information in the entry area 140 and operates a transmission button, and the transmission section 130 transmits the user identification information received by the user information reception section 122, to the game server 14. In the game server 14, the user identification section 222 receives the information for identifying the user B (S12), and the agent generation section 220 trains the machine learning model by using the user data of the user B, so that an agent of the user A is generated (S14). By using the user data of the user B who is different from the user A in the above-mentioned manner, the agent generation section 220 can generate an agent to play a game on behalf of the user A. In a case where the agent of the user A is generated on the basis of the user data of the user B, the play style and skill of the agent of the user A closely resemble those of the user B.

FIG. 7 depicts another example of an inquiry screen displayed on the output apparatus 4. The user A enters information for identifying a user whose user data is to be learned, in the entry area 140 on the inquiry screen, and enters, in an entry area 142, the degree of reflection at which the user data is to be reflected in the learning (hereinafter, also referred to as the “degree of reflection”). In the entry area 140, the user can enter information for identifying two or more (that is, multiple) users. The user information reception section 122 receives a selection of the user B, a user C, and a user D.

In the first embodiment, the degree of reflection means a degree of reflection of user data in generation of an agent, and represents a relative quantity of user data to be used for training the machine learning model. The degree of reflection being 0% means that the user data is not reflected in generation of an agent, and thus a percentage entered in the entry area 142 is greater than 0. The reflection degree reception section 124 receives the degrees of reflection of user data of respective users. In this example, 40%, 40%, and 20% are entered as the degree of reflection of the user data of the user B, the degree of reflection of the user data of the user C, and the degree of reflection of the user data of the user D, respectively.

The user A enters user identification information in the entry area 140, enters a degree of reflection in the entry area 142, and operates the transmission button. Then, the transmission section 130 transmits the user identification information received by the user information reception section 122 and the degree of reflection received by the reflection degree reception section 124 to the game server 14. In the game server 14, the user identification section 222 receives the information for identifying the user B, the user C, and the user D, the reflection degree specification section 224 specifies the degree of reflection of user data of each user (S12), and then the agent generation section 220 causes the machine learning model to learn the user data of the user B, the user C, and the user D according to the specified degrees of reflection, whereby an agent of the user A is generated (S14).

Specifying the degrees of reflection of the user data of the user B, the user C, and the user D to 40%, 40%, and 20% respectively means that the relative ratio of the user data quantities of the user B, the user C, and the user D used for learning in the machine learning model is 2:2:1. Accordingly, the agent generation section 220 generates an agent of the user A by using the user data of the respective users in such a way that the ratio of the user data quantity of the user B, the user data quantity of the user C, and the user data quantity of the user D is 2:2:1.

Each user data quantity may be defined by a play time period, or may be defined by the number of times of plays. For example, to learn game plays of one stage (stage X) in a game, the agent generation section 220 may generate an agent of the user A by causing the machine learning model to learn play data regarding a 2 hour play in the stage X performed by the user B, play data regarding a 2 hour play in the stage X performed by the user C, and play data regarding a 1 hour play in the stage X performed by the user D. Alternatively, the agent generation section 220 may generate an agent of the user A by causing the machine learning model to learn play data regarding 10 plays in the stage X performed by the user B, play data regarding 10 plays in the stage X performed by the user C, and play data regarding 5 plays in the stage X performed by the user D.

The relative ratio of the user data quantities to be learned has an influence on the play style or skill similarity between the agent and the user. In this case, therefore, a play style or skill of the generated agent of the user A are so set as to closely resemble play styles or skills of the user B and the user C, and slightly resemble a play style or skill of the user D.

In the above example, the user A designates a user who is different from the user A. Alternatively, the user A may designate the user A. In addition, the entry area 142 for entry of the degree of reflection is not disposed on the inquiry screen depicted in FIG. 6, but the degree of reflection may be entered also in a case where the user A designates one user (another user or the user A). By way of example, in a case where the user A is entered in the entry area 140 and 50% is entered in the entry area 142, the user identification section 222 may randomly select a user other than the user A, and the agent generation section 220 may generate an agent of the user A using the user data of the user A and the user data of the randomly selected user in such a way that the ratio of the user data quantity of the user A and the user data quantity of the randomly selected user is 1:1.

### Second Embodiment

In the first embodiment, the user A selects and designates user data to be learned. Alternatively, the game server 14 may automatically select user data to be learned. In the second embodiment, the user identification section 222 identifies another user who exhibits a personality that is similar to the personality of the user A. The user identification section 222 may identify another user having user information that is similar to the user information 244 of the user A.

In the embodiment, the user information 244 includes “Login information,” “Genre of game to be played,” “Personal information,” “Information regarding acquired trophies,” “Information regarding friends,” etc. The “Login information” is history information regarding the user A's logins to the terminal apparatus 10, and describes the frequency of the logins, the time periods of the logins, and the like. The “Genre of game to be played” describes whether the user A likes shooting games, or whether the user A likes puzzle games, etc. The “Personal information” is personal information regarding the user A, and may include the age, sex, and residence area of the user A, and information regarding purchases of games at a store. The “Information regarding acquired trophies” is information for identifying trophies acquired by the user A so far, and describes whether the user A has a play style of collecting trophies or the user A has a play style of preferentially clearing games without sticking to trophies. Alternatively, the “Information regarding acquired trophies” may describe which type of trophies the user A is likely to acquire (for example, whether the user likes a trophy associated with the story, whether the user likes a trophy obtained from a mini game, or the like). The “Information regarding friends” is information regarding users registered as user's friends, and describes friends connected with the user A.

The user identification section 222 identifies another user having user information that is similar to the user information 244 of the user A (S12). The similarity between these pieces of user information may be evaluated by comparison of respective vectors of these pieces of user information. In the embodiment, evaluating a user information similarity may be realized by an existing technology. In the evaluation, the user identification section 222 may identify one or more users having similar user information. The agent generation section 220 trains the machine learning model by using the user data of the identified one or more users, whereby an agent of the user A is generated (S14). The generated agent is reflective of the personality of the user A.

Also in the second embodiment, the user A may be allowed to specify a degree of reflection of user data in generation of an agent (degree of reflection).

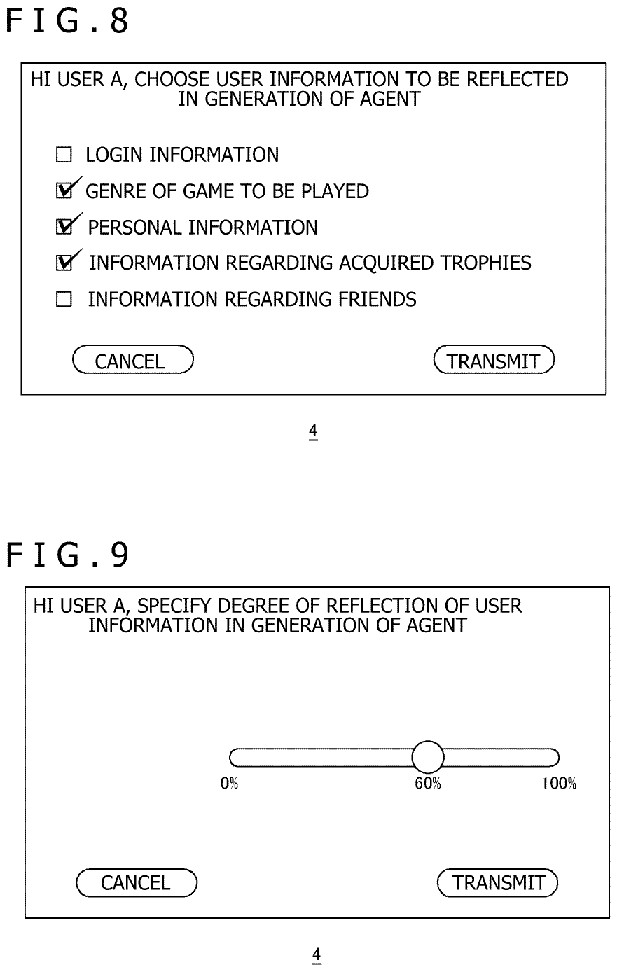

FIG. 8 depicts an example of a user data reflection degree specification screen. Multiple selectable items of user information are displayed on the specification screen. When the user A selects a user information item to be reflected in generation of an agent, the reflection degree reception section 124 receives information for identifying the selected item. In the example depicted in FIG. 8, “Genre of game to be played,” “Personal information,” and “Information regarding acquired trophies” are selected. When the user A selects the items and operates the transmission button, the transmission section 130 transmits the item identification information received by the reflection degree reception section 124 to the game server 14.

In the game server 14, the reflection degree specification section 224 specifies user information items for identifying a user whose personality is similar to the personality of the user A on the basis of the item identification information, and the user identification section 222 identifies another user having user information that is similar to the user information of the user A on the basis of the specified user information items (S12). Here, the user identification section 222 identifies one or more users having user information including “Genre of game to be played,” “Personal information,” and “Information regarding acquired trophies” that are similar to those in the user information of the user A. The agent generation section 220 trains the machine learning model by using the user data of the identified one or more users, whereby an agent of the user A is generated (S14). The generated agent is reflective of the personality of the user A in connection with the specified items.

FIG. 9 depicts another example of a user data reflection degree specification screen. A user interface for specifying the degree of reflection of user information in generation of an agent is displayed on the specification screen. The user interface includes a bar in which the left end indicates 0% and the right end indicates 100%, and a slider which is movable on the bar. The user A determines the position of the slider on the bar, and the reflection degree reception section 124 receives information for identifying user information. In the example depicted in FIGS. 9, 60% is selected as the degree of reflection of user information in generation of an agent.

When the user A specifies the degree of reflection of user information regarding the specification screen depicted in FIG. 9, user information corresponding to the specified degree is selected from among “Login information,” “Genre of game to be played,” “Personal information,” “Information regarding acquired trophies,” and “Information regarding friends” depicted in FIG. 8. By way of example, user information of “Login information” is selected when the user selects 20%, and user information of “Login information,” “Genre of game to be played,” and “Personal information” is selected when the user selects 60%, and user information of “Login information,” “Genre of game to be played,” “Personal information,” “Information regarding acquired trophies,” and “Information regarding friends” is selected when the user selects 100%. In this manner, the user information is selected on the basis of the priority levels and the specified degree. Here, the priority order of selecting user information from the highest is “Login information,” “Genre of game to be played,” “Personal information,” “Information regarding acquired trophies,” and “Information regarding friends,” but the priority order of the items may be changed if needed. Further, the user information items may include an item other than those depicted in FIG. 8.

In the example depicted in FIG. 9, 60% is selected. The reflection degree reception section 124 receives item identification information for identifying “Login information,” “Genre of game to be played,” and “Personal information” according to the priority levels. When the user A operates the transmission button, the transmission section 130 transmits the item identification information received by the reflection degree reception section 124 to the game server 14.

In the game server 14, the reflection degree specification section 224 specifies user information items for identifying a user whose personality is similar to the personality of the user A on the basis of the item identification information, and the user identification section 222 identifies another user having user information that is similar to the user information of the user A on the basis of the specified user information items (S12). Here, the user identification section 222 identifies one or more users having user information including “Login information,” “Genre of game to be played,” and “Personal information” that are similar to those in the user information of the user A. The agent generation section 220 trains the machine learning model by using user data of the specified one or more users, whereby an agent of the user A is generated (S14). The generated agent is reflective of the personality of the user A in connection with the specified items.

In the first and second embodiments, user data used for training the machine learning model may be limited to user data recorded in the recording during a designated predetermined time period. The user A designates a time period of recording of the user data, whereby an agent that imitates a play style of the user A or another user during the designated time period can be generated.

In the first and second embodiments, in a case where the user data 242 of another user is used for generation of an agent of the user A, the game system 1 may construct a mechanism to receive a payment from the user A for use of the user data 242. By way of example, in a case where the user A generates an agent by using the user data 242 of a famous game player, the user A may be allowed to purchase the user data 242 of the famous game player.

In the first and second embodiments, a restriction may be imposed on the number of agents generated for a user, and the restricted number may be loosened if the user subscribes to a predetermined service. In addition, an agent generated for a user may be available to another user. In this case, the game system 1 counts usages of the agent by other users, and may publish a ranking according to the usage counts. For example, a bonus such as a trophy may be given to a user who generated an agent whose usage count is large.

### Third Embodiment

The agent generation section 220 trains the machine learning model by using user data in the above-mentioned manner, whereby an agent of the user A is generated. After the agent is generated, the user A can send a request for an agent's game play to the game server 14.

The request reception section 120 receives a request for an agent's game play from the user A, and the transmission section 130 transmits the request for an agent's game play to the game server 14. In the game server 14, the request reception section 226 receives the request for an agent's game play. Then, the game execution section 212 executes a game program, and the game play controller 230 initiates the agent of the user A. The agent of the user A as a player generates a command for the game, and the game execution section 212 generates a play image according to a game operation performed by the agent. The streaming data transmission section 214 transmits streaming data including the play image to the terminal apparatus 10 of the user A.

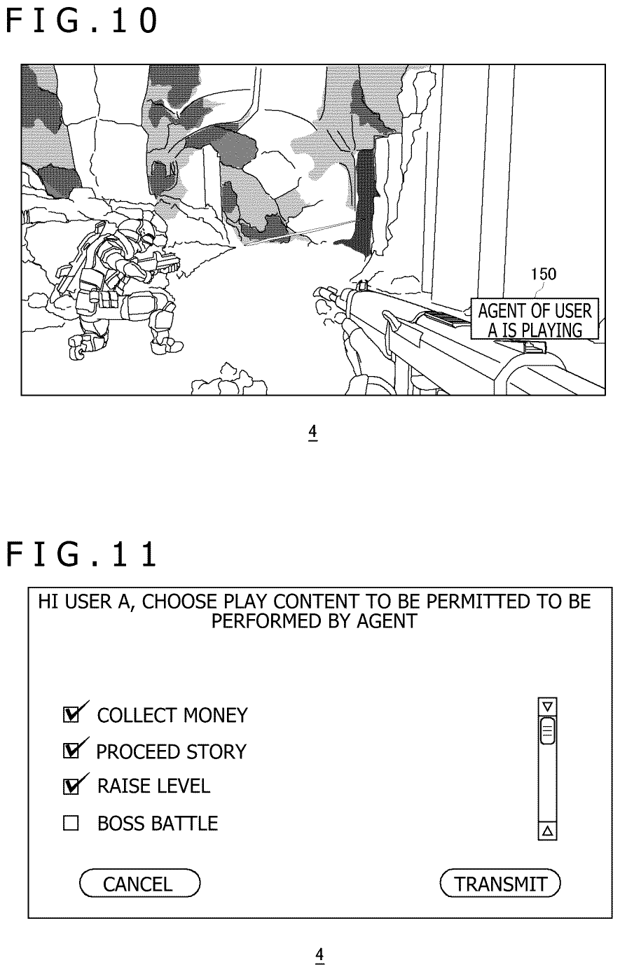

During the agent's game play, the game execution section 212 may add, to a character that is under the agent operation, a marker indicating that the character is being operated by the agent. FIG. 10 depicts an example of a play image of a game being operated by an agent. In the terminal apparatus 10, the data acquisition section 112 acquires the streaming data from the game server 14, and the display processing section 114 displays, on the output apparatus 4, the play image of the game being operated by the agent. In FIG. 10, a character under the operation of the agent of the user A is provided with a marker 150 indicating that the character is being operated by the agent. In particular, when the agent plays the game in a multiplayer gaming session, a user who is different from the user A looks at the marker 150 and recognizes that the agent of the user A is playing.

The agent plays a game on behalf of the user A. However, if the agent is allowed to play all play contents, the agent clears the game while the user A does not play the game at all. Therefore, the play content specification section 228 specifies a play content to be permitted or not permitted to be performed by the agent. In response to a request from the user A, the play content specification section 228 may specify a play content to be permitted or not permitted to be performed by the agent.

For example, a “Boss battle” which is a battle with an enemy boss is a climax of the game. The user A desires to play the boss battle, that is, desires to prohibit the agent from playing the battle. Meanwhile, a play content corresponding to raising a level is usually a time-consuming and dull task. The user A desires to cause the agent to play such a task on behalf of the user A. For example, the agent raises the level when the user A is doing work. Accordingly, when finishing the work, the user A can play the game by using a character having reached a high level.

In the game server 14, when the request reception section 226 receives an agent play request, the game play controller 230 may make an inquiry about a play content permitted to be performed by the agent, to the terminal apparatus 10 of the user A.

FIG. 11 depicts an example of a play content specification screen. On this specification screen, the user A selects which play content is to be permitted to be performed by the agent. Alternatively, a specification screen for selecting which play content is not permitted to be performed by the agent may be offered.

The specification screen depicted in FIG. 11 offers, as play contents, selection items of “Collect money,” “Proceed story,” “Raise level,” and “Boss battle.” Since the user A selects the play contents excluding the boss battle, the agent is permitted to perform the plays excluding the boss battle. After the user A selects a play content to be permitted to be performed by the agent, the play content reception section 126 receives the selected play content, and the transmission section 130 transmits the selected play content to the game server 14. It is to be noted that items other than those depicted in FIG. 11 may be provided as play contents to be permitted to be performed by the agent. For example, “Permit usage of MP (magic points)” and “Permit usage of an item” may be included. In this case, a selection for specifying the percentage of held MP or items to be permitted to be used may be further offered.

In the game server 14, the play content specification section 228 specifies play contents to be permitted to be performed by the agent. Specifically, the play content specification section 228 registers a set (combination) of play contents to be permitted to be performed by the agent, as a play content set 252 in the recording device 240. After the play content set 252 is registered, the game play controller 230 causes the agent to play the game according to the play contents defined in the play content set 252. In this case, the agent is permitted to play the play contents excluding the boss battle. Thus, when the game scene moves to the boss battle, the battle is skipped to another game content and the agent behaves to play the other game contents. If any game content other than the boss battle cannot be played in light of the progress of the story, the agent behaves to stop the game play at this time point.

It is to be noted that the user A may register the multiple play content sets 252 in the recording device 240. For example, only the boss battle is prohibited in a certain play content set 252, while the boss battle and proceeding the story are permitted in another play content set 252. Further, all the play contents including the boss battle may be permitted in still another play content set 252. Multiple play content sets 252 for determining which play content is permitted to be performed by the agent may be previously registered in this manner such that one of the multiple play content sets 252 may be selected when an agent's game play is requested to the game server 14.

The user A may set the play content sets in such a way that play contents permitted to be performed by the agent when the user is out and not at home half a day are different from play contents permitted to be performed by the agent when the user eats a meal at home for one hour. Therefore, it is preferable that the multiple play content sets 252 be previously registered in the game server 14 in order to allow the user A to select a play content set 252 for use according to the condition of the user A. The user A may select the play content set 252 when inputting an agent's play request through the input apparatus 6.

In this case, the request reception section 226 receives the agent's play request as well as a selection of the play content set 252. Therefore, the game play controller 230 can control the agent's game play according to the selected play content set 252.

The game play controller 230 records play data regarding a game play performed by the agent as agent play data 250 in the recording device 240. The agent play data 250 is data for reproducing the game play performed by the agent, and may be generation history data including the association between a command (or operation information) generated by the agent and the time of the generation. £ By using the agent play data 250, the user A can watch an image of the agent's play.

The request reception section 120 receives an agent's game play reproduction request from the user A, and the transmission section 130 transmits the game play reproduction request to the game server 14. In the game server 14, the request reception section 226 receives the game play reproduction request, and the game execution section 212 executes the game program by using the agent play data 250 and reproduces the agent's game play. The game execution section 212 may increase the speed of the reproduction in response to a user request. The user A can play the game from any time point in the agent's game play. In this case, the user A designates a temporal position in the agent's game play, and the transmission section 130 transmits a game play start request and the designated temporal position to the game server 14.

In the game server 14, the game execution section 212 receives the game play start request and the designation of the temporal position, and executes the game from the position according to a user operation. Since the agent play data 250 is recorded in this manner, the user A can check an agent's game play, and amend the game play from a desired temporal position.

The user A may cause the agent to perform a game play from a certain break position several times. The user A may check these game plays by using the agent play data 250, and feed back the check result to training of the machine learning model. Further, a time period in which the agent is caused to play the game may be included in a profile of the user A. Further, information indicating whose user data is used to generate the agent may be included in a profile of the agent.

The present disclosure has been explained so far on the basis of the embodiments. The embodiments have been given for illustrative purposes only. A person skilled in the art will understand that various modifications can be made to a combination of the constituent elements or the process steps in the embodiments and that these modifications are also within the scope of the present disclosure.

### INDUSTRIAL APPLICABILITY

The present disclosure is applicable to a technology of generating an agent to play a game on behalf of a user and/or a technology of controlling a game play being performed by an agent.

### REFERENCE SIGNS LIST

1: Game system
2: Auxiliary storage apparatus
3: Network
4: Output apparatus
6: Input apparatus
7: Camera
8: AP
10: Terminal apparatus
12: Cloud system
14: Game server
18: Management server
100: Processing section
102: Communication section
110: Operation information reception section
112: Data acquisition section
114: Display processing section
120: Request reception section
122: User information reception section
124: Reflection degree reception section
126: Play content reception section
130: Transmission section
140, 142: Entry area
150: Marker
200: Processing section
202: Communication section
210: Operation information reception section
212: Game execution section
214: Streaming data transmission section
220: Agent generation section
222: User identification section
224: Reflection degree specification section
226: Request reception section
228: Play content specification section
230: Game play controller
240: Recording device
242: User data
244: User information
246: User play data
250: Agent play data
252: Play content set

1. An information processing apparatus comprising:
a recording device that records user data including user information regarding multiple users and/or play data about game plays performed by multiple users; and
at least one processor having hardware, wherein the at least one processor:
identifies a second user who is different from a first user, and
generates an agent to play a game instead of the first user, using user data of the second user.

2. The information processing apparatus according to claim 1, wherein the at least one processor receives information for identifying the second user from the first user.

3. The information processing apparatus according to claim 1, wherein the at least one processor identifies the second user who has user information that is similar to user information of the first user.

4. An information processing apparatus comprising:
a recording device that records user data including user information regarding a user and/or play data about a game play performed by a user; and
at least one processor having hardware, wherein the at least one processor:
specifies a degree of reflection of the user data in generation of an agent to play a game, and
generates an agent using the user data according to the specified degree.

5. The information processing apparatus according to claim 4, wherein:
the recording device records user data of multiple users, and
the at least one processor generates an agent using user data of at least two users.

6. The information processing apparatus according to claim 5, wherein the at least one processor:
specifies a degree of reflection of user data of each of the at least two users in generation of an agent, and
generates an agent using the user data of the at least two users according to the specified degree.

7. The information processing apparatus according to claim 4, wherein
the recording device records user data of multiple users, and
the at least one processor:
receives information for identifying a second user from a first user, and
specifies a degree of reflection of user data of the second user in generation of an agent of the first user.

8. The information processing apparatus according to claim 4, wherein:
the recording device records user data of multiple users, and
the at least one processor:
identifies a second user who has user information that is similar to user information of a first user according to the specified degree, and
generates an agent of the first user using user data of the second user.

9. The information processing apparatus according to claim 4, wherein the degree of reflection in generation of an agent is represented by a percentage.

10. The information processing apparatus according to claim 4, wherein the at least one processor generates an agent using the user data recorded within a designated time period.

11. An agent generation method of generating an agent to play a game in an information processing apparatus, the method comprising:
identifying a second user who is different from a first user; and
generating an agent to play a game instead of the first user, using user data including user information regarding the second user or play data about a game play performed by the second user.

12. A computer to realize comprising:
at least one processor; and
a memory storing a program which, when executed by the at least one processor, cause the computer to perform operations comprising:
identifying a second user who is different from a first user; and
generating an agent to play a game instead of the first user, using user data including user information regarding the second user or play data about a game play performed by the second user.

13. An agent generation method of generating an agent to play a game in an information processing apparatus, the method comprising:
specifying a degree of reflection of user data in generation of an agent to play a game, the user data including user information regarding a user and/or play data about a game play performed by a user; and
generating an agent using the user data according to the specified degree.

14. A computer comprising:
at least one processor; and
a memory storing a program which, when executed by the at least one processor, cause the computer to perform operations comprising:
specifying a degree of reflection of user data in generation of an agent to play a game, the user data including user information regarding a user and/or play data about a game play performed by a user; and
generating an agent using the user data according to the specified degree.
